(19) United States
(12) Patent Application Publication
(10) Pub. No.: US 2012/0253849 A1
(43) Pub. Date: Oct. 4, 2012

(54) SYSTEM AND METHOD FOR STANDARDIZING ELECTRONIC REGISTRATION

(76) Inventors: Steven T. Parker, Fishers, IN (US); Nicholas J. Nicklyn, Noblesville, IN (US); Jonathan E. Ziebell, Noblesville, IN (US)

(21) Appl. No.: 13/436,266

(22) Filed: Mar. 30, 2012

Related U.S. Application Data
(60) Provisional application No. 61/469,139, filed on Mar. 30, 2011.
(60) Provisional application No. 61/547,774, filed on Oct. 17, 2011.

(51) Int. Cl. G06Q 50/24

(52) U.S. Cl. 705/3

(57) ABSTRACT

A method for standardizing patient registration includes a step of allowing a patient to one of create an account on a data management system and manage the account that has been previously created on the data management system. The account has patient information entered into the account by the patient. The patient is permitted to authorize a sharing of at least a portion of the patient information in the account with a healthcare provider. The healthcare provider is provided with access to the portion of the patient information in the account authorized for the sharing by the patient via the data management system. The healthcare provider can further request additional information from the patient for their own data collection purposes, all done through the same mechanism as perceived by the patient.

### CROSS-REFERENCE TO RELATED APPLICATIONS

This application claims the benefit of U.S. Provisional Application No. 61/469,139 filed on Mar. 30, 2011, and U.S. Provisional Application No. 61/547,774 filed on Oct. 17, 2011. The entire disclosures of the above applications are hereby incorporated herein by reference.

### FIELD OF THE INVENTION

The present invention relates generally to systems and methods for managing and transferring healthcare related information.

### BACKGROUND OF THE INVENTION

When a patient visits a healthcare entity (e.g., a provider, a medical facility, etc.), there is a need to obtain information from the patient. Typically, a patient fills out paper medical history forms, particularly when it is the first visit with a doctor, while waiting to see the healthcare entity. In addition to providing the medical history, the patient provides personal information required by the healthcare provider for registration of the patient. The patient is also prompted to provide insurance information and other billing-related information, along with financial agreements and any other information the healthcare entity requires.

Currently, there exists no singular option where patients can enter the medical history, insurance, and other information required by the healthcare entity electronically through an Internet-accessible website, and subsequent give access to or submit that information to any authorized healthcare entity.

Furthermore, there is no ability to have the information saved to a secured electronic profile that can be re-used for non-related healthcare provider registrations, which may include additional data collection points specific to the non-related provider's registration requirements.

Some healthcare entities provide on-line registration prior to a visit. However, these on-line registrations are typically very brief, do not allow for saved information to be re-used, do not provide a sharing of the information to other providers/non-related entities, and does not use the saved information in conjunction with “smart” questions that ask additional questions based on the circumstances of the visit.

Additionally, hospitals and health care providers have limited means to determine whether a particular patient is eligible for health insurance coverage. When a patient seeks health care at a hospital, the admitting staff usually asks the patient whether the patient has health insurance. Often, the admitting staff will ask the patient for evidence of health insurance eligibility (e.g., a medical insurance card or the like). Information corresponding to the health insurance coverage is inputted into a computerized patient admissions system.

Health insurance coverage, such as Medicaid and Medicare, is often determined on a periodic basis (e.g., weekly or monthly) such that the insurance rolls are constantly changing. For this reason, it is important for hospitals and other health care providers to obtain timely, accurate and complete health insurance eligibility information for each incoming patient.

Although the admissions clerk might be able to pick up a telephone and dial the telephone number of an information service or the patient's asserted health care provider to obtain an oral verification of insurance coverage, circumstances often do not permit such activity, and not all insurance companies provide this ability.

Alternatively, many hospitals and other health care providers have “POS” (“point of sale”) terminals and/or personal computers that can link electronically over telephone lines with “information providers” sometimes called “clearinghouses” that verify health insurance coverage eligibility. However, these techniques require the admitting clerk to decide to check health insurance eligibility, and then take additional steps necessary to verify.

The current methods and techniques suffer from the drawback that verifying insurance eligibility is not automatic. If the admissions clerk is busy, he or she may not have sufficient time to verify the eligibility of some or all incoming patients. Additional problems arise when a billing department tries to collect from the insurance company, and in the worst case, can cause the hospital to lose the ability to recover costs and fees for health care.

To add even further complication, health insurance eligibility is often not capable of being fully specified by a “yes” or a “no” answer. In the increasingly complicated world of health insurance, eligibility may involve qualifications, particular benefits packages, and other important additional information. For example, hospitals often need to know whether the hospital is a member of the patient's managed care group. In addition, the hospital may need to know about co-payment arrangements as well as the patient's previous health care services provided under a certain insurance coverage. These additional complications make eligibility verification more time consuming and difficult—making it even less likely that proper verification will be obtained at the time of patient admission.

Because of the various pressures involved in a health care provider admissions office, where the prime concern is usually to provide needed care to incoming patients as rapidly as possible, and because of the various complexities mentioned above, many hospitals have no reliable system or procedure for receiving accurate registration information and verifying that each incoming patient is actually eligible for the insurance coverage he or she asserts. Many times, registration information and health insurance coverage eligibility is not verified until after the patient has left the hospital or other health care provider, and the hospital or provider is attempting to collect payment for services rendered in the past. By this time, it may not be possible to locate the patient to obtain further information about his or her information. This results in great inefficiencies, wasted effort in attempting to collect from the wrong insurers, and loss of revenue and cost recovery to the health care providers.

Additionally, when a patient travels from one healthcare provider to the next, much of the required information requested by said provider of the patient is similar in nature across those encounters. Having the patient constantly re-enter the same information is time consuming and inefficient for the patient.

It would be desirable to develop a data management system and a method of standardizing patient registration, wherein the system and the method overcome the shortcomings of the prior art.

### SUMMARY OF THE INVENTION

In concordance with the instance disclosure, a data management system and a method of standardizing patient registration that overcomes the shortcomings of the prior art, has surprisingly been discovered.

The invention is directed to a system and method for standardizing, in an electronic format, patient related healthcare information in which the patient controls the digital repository and authorizes access to that data to healthcare entities at their discretion.

In one embodiment, a method for standardizing patient registration includes a step of allowing a patient to one of create an account on a data management system and manage the account that has been previously created on the data management system. The account has patient information entered into the account by the patient. The patient is permitted to authorize a sharing of at least a portion of the patient information in the account with a healthcare provider. The healthcare provider is provided with access to the portion of the patient information in the account authorized for the sharing by the patient via the data management system.

In another embodiment, a data management system for standardizing patient registration includes a database, a patient interface, a processor, and a healthcare provider interface. The patient interface is in communication with the database. The patient interface is configured to transfer patient information in an account on the database to and from the database. The processor is in communication with the database. The processor is configured to retrieve the patient information. The healthcare provider interface is in communication with the database. The healthcare provider interface is also configured to receive at least a portion of the patient information in a standardized format.

In a further embodiment, a method includes a step of providing of the data management system of standardizing patient registration. Authorization to access the at least the portion of the patient information in the account is then received from the patient. The portion of the patient information in the account via the healthcare provider interface is subsequently accessed. The portion of the patient information is provided in a standardized format.

### DRAWINGS

The above, as well as other advantages of the present invention, will become readily apparent to those skilled in the art from the following detailed description of the preferred embodiment when considered in the light of the following drawings in which:

FIG. 1 is a schematic block diagram of a data management system according to an embodiment of the present disclosure;

FIGS. 2-6 are illustrative screen shots of a data management system according to a particular embodiment of the present disclosure, and shown from a healthcare provider's perspective; and

FIGS. 7-21 are illustrative screen shots of a data management system according to a particular embodiment of the present disclosure, and shown from a patient's perspective.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

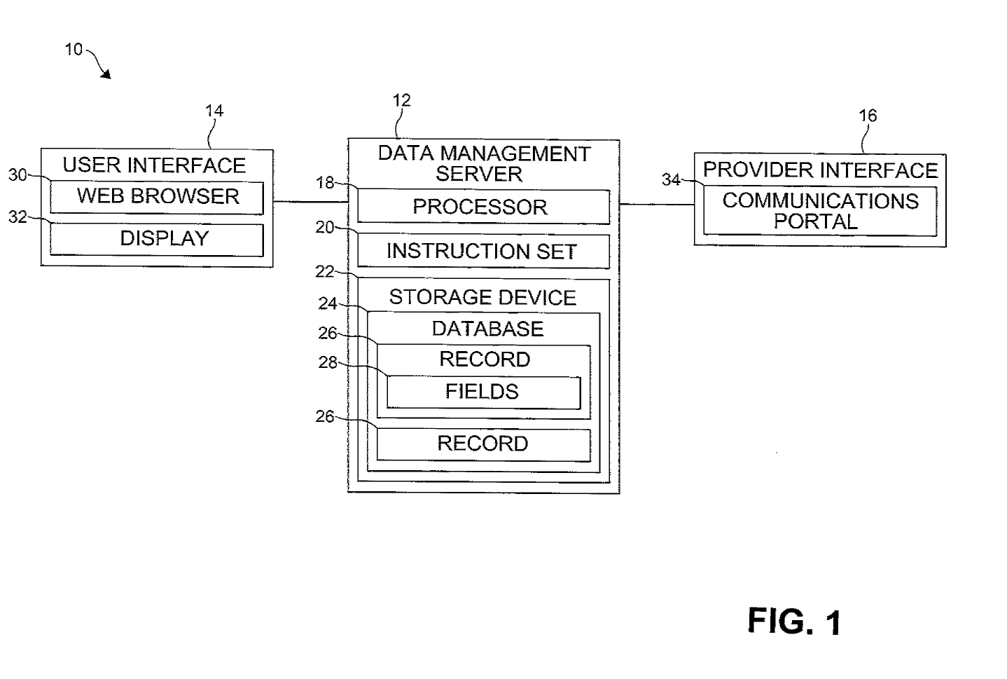

FIG. 1 illustrates a data management system 10 for standardizing healthcare practices according to one embodiment of the disclosure. As shown, the system 10 includes a central management server 12, a user interface 14, and a provider interface 16. However, any number of components can be included in the system 10.

The management server 12 can be any server or computer system for collecting and storing user (e.g., a patient) and provider (e.g., a healthcare provider, insurance provider, etc.) information in a standardized format to be selectively communicated to a particular recipient. As a non-limiting example, various communication devices are able to interact with the management server 12 to send and receive information and data therebetween. As a further non-limiting example, the user interface 14 and the provider interface 16 are in communication with the management server 12 through at least one of a private intranet, a public internet, a local area network (LAN), a dial-up-connection, a cable modem, and a high speed ISDN line, for example. Other network devices may be used to interconnect the management server 12 and at least one of the user interface 14 and the provider interface 16 such as a wireless network, for example.

In the embodiment shown, the management server 12 includes a processor 18 for analyzing, organizing, and managing a data transmitted/received by the management server 12. As shown, the processor 18 analyzes and evaluates the data upon an instruction set 20. The instruction set 20, which may be embodied within any computer readable medium, includes processor executable instructions for configuring the processor 18 to perform a variety of tasks. It is understood that the processor 18 may execute a variety functions such as organizing and standardizing a data into a pre-defined format, establishing a connection with a communication portal of an insurance company, validating an insurance eligibility, generating a feedback of information to a user or provider, and managing an electronic scheduler, for example. However, any function or task can be executed by the processor 18 based on the instruction set 20 or other means of processor control. It is further understood that the instruction set 20 can be embodied as a web application.

In certain embodiments, the management server 12 includes a storage device 22. The storage device 22 may be a single storage device or may be multiple storage devices. Furthermore, the storage device 22 may be a solid state storage system, a magnetic storage system, an optical storage system or any other suitable storage system or device. It is understood that the storage device 22 is adapted to store the instruction set 20. Other data and information may be stored and cataloged in the storage device 22 such as the data collected by the user interface 14 and the provider interface 16, for example. The storage device 22 is adapted to manage data stored in a database 24 and interconnections between the database 24 and various resources not stored in the database 24. The storage device 22 may also be adapted to perform operations such as, a data query, a data transfer, a data retrieval, and a data processing, for example. It is understood that other devices may be used to manage the data stored in the database 24 such as a software engine and a software package, for example.

In certain embodiments, the database 24 includes a plurality of records 26, wherein each record includes data relating to a particular user or provider. As a non-limiting example, each of the records 26 have a plurality of pre-defined fields 28 that are populated by a user-provided input. As a further non-limiting example, the fields 28 are based upon a universal registration template including information required by a typical physician in order to register a new patient. It is understood that any number of the fields 28 can be used.

The user interface 14 is adapted to transfer data to and from the management server 12. In one embodiment, the user interface 14 is a computer including a web browser 30 and is adapted for data transfer between the user interface 14 and the management server 12. The web browser 30 may be any browser for providing remote user access to the management server 12. It is understood that the user interface 14 may be any user access device capable of interconnecting to the management server 12 such as a web-capable mobile phone, a personal digital assistant (PDA), and other mobile electronic devices, for example. It is further understood that the user interface 14, may include any number of user access devices, as desired. Any number of user interfaces 14 may be interconnected to the management server 12, as desired.

In certain embodiments, a user can create one of the records 26 through the user interface 14 (e.g. web application). The user can populate the fields 28 with a required information and the record 26 can store the user-provided information for subsequent processing and retrieval.

In certain embodiments, the user interface 14 includes a display 32 for presenting a visible output to the user. As a non-limiting example, the display 32 can generate a visual feedback representing one of the records 26 associated with the particular user (e.g. personal information, health-related information, insurance related information, a digital copy of an insurance card, a healthcare provider schedule calendar, etc.). As a further non-limiting example, the display 32 can generate a visual feedback to facilitate particular tasks such as locating a physician, scheduling an appointment, updating a user data, and retrieving user data

The provider interface 16 is adapted to transfer data to and from the management server 12. In one embodiment, the provider interface 16 is a computer including a communications portal 34 for data transfer (e.g. secured) between the provider interface 16 and the management server 12. It is understood that the provider interface 16 may be any user access device capable of interconnecting to the management server 12 such as a web-capable mobile phone, a personal digital assistant (PDA), and other mobile electronic devices, for example. It is further understood that the provider interface 16, may include any number of user access devices, as desired. Any number of provider interfaces 16 may be interconnected to the management server 12, as desired. In certain embodiments, the provider interface 16 is integrated with a patient management system (not shown) associated with the particular healthcare provider, wherein information received by the provider interface 16 is automatically propagated throughout the patient management system. As a non-limiting example, the provider interface 16 is HL7 compatible.

In operation, a user provides a user data to the management server 12 and the management server 12 creates one of the records 26 including the user data (e.g. a health history, a demographic information, a personal information, an insurance carrier, and a policy of the user). The system 10 automatically validates an eligibility (e.g. similar to a 270/271 transaction known in the art) and provides feedback to the user regarding insurance coverage, deductibles for particular treatments and healthcare providers, policy information. A standardized output file is transmitted to a selected one of the provider interfaces 16, wherein the output file includes the user data (e.g. a requisite registration and insurance information to expedite administrative requirements of the healthcare provider) and a indicator of the eligibility of the user (i.e. a result of the validation executed by the management server 12). As a non-limiting example, the validation of eligibility can be based upon a particular treatment and/or healthcare provider. As a further non-limiting example, the standardized format is HL7 compliant in order to facilitate the expedited propagation of information into a recipient's local computer system. However, any standard (non-proprietary) format can be used in order to facilitate a universal pre-registration of patients prior to a actual office visit.

In certain embodiments, the user can interact with the management server 12 to schedule an appointment with a healthcare provider. As a non-limiting example, the database 24 can store a location based catalogue of healthcare providers and their respective electronically “shared” schedules. The management server 12 is adapted to query the database 24 and to generate an applicable list of available appointments to a particular user.

In certain embodiments, the user can interact with the management server 12 to store any amount of health related data including payment data such as a billing information. As such, the billing information can be transmitted to a selected one of the provider interfaces 16 in order to pre-pay on an account or to expedite the billing process.

In certain embodiments, the user can interact with an online account of a particular insurance carrier through the management server 12. As such, the user can access any information provided by the carrier through an account of the carrier.

The system 10 and the method of operation of the present invention provide a universal pre-registration of patients, an insurance eligibility verification, a portal to access insurance information (e.g. policy, coverage, deductible pre-calculation, a digital copy of an insurance card), a physician locator, a scheduler for healthcare appointments, and a data storage of personal health-related information, for example.

Specifically, the system 10 and the method of the present invention provide a universal clearinghouse to collect and store patient information in a standard format to be selectively communicated to a particular healthcare provider. The standardized format allows the recipient healthcare provider to process the requisite registration and insurance information prior to a scheduled appointment. Further, the system 10 and method provide a single online location to manage personal healthcare related activities, while maximizing the transparency of insurance coverage and related costs.

In illustrative embodiments, the system 10 and method of the present disclosure allows any person to create and manage an electronic “account” that contains various components of information related to, but not limited to, items asked and needed in the healthcare setting. The account may contain demographic information about the patient (e.g., first name, last name, middle initial, address, city, state, zip, gender, race, ethnicity, phone numbers, birth date, social security number), responsible party to the patient (e.g., same or similar information), emergency contact to the patient (e.g., same or similar information), subscriber listed for each insurance coverage (e.g., same or similar information), insurance policy identification numbers, patient medical history, family medical history, social history, active and historical prescription information, healthcare provider specific information, data requested by the healthcare provider and various other inputs. The account may also include other information, as desired.

Once created, information represented by the account is accessible only by the patient and any other person(s) that the patient has authorized. This authorization may allow all or any subset of information represented by the account to be accessed.

The account can be created and accessed by various electronic methods, for example, as described hereinbelow. The patient can access the invention by an Internet website, defined as accessible by any compatible web browser from any connected location. Nonbrowser-based Graphical User Interface (GUI) software applications may be allowed to interact with and provide access to account. Additionally, there are also non-GUI software methodologies that will allow data to be read/written to the account, including an associated data repository, with the intent to serve the same purpose as the GUI. The account may be created and accessed via a mobile phone application. Direct interfaces may also be used to create and access the account. Other means for creating and accessing the account may also be used within the scope of the disclosure.

Healthcare providers utilize the system 10 and method of the present disclosure to retrieve the patient information released and represented by the patient account. Since the patient controls the account, healthcare providers from different non-related affiliations are may also be permitted to be eligible for access to the data of the account, as desired.

Advantageously, the healthcare entity does not host, manage, or otherwise control through third party vendor relationship the data and control represented by the patient account. This inherently allows for the patient to have a single account containing all of the information described previously that can be distributed to any number of dissimilar healthcare entities via patient controlled authorization by both electronic and non-electronic means.

Authorized healthcare providers retrieve information released from the patient account by the various electronic and non-electronic methodologies described hereinbelow.

The healthcare entity can access the invention by a Website, defined as accessible by any compatible web browser from any connected location. Nonbrowser-based Graphical User Interface (GUI) software applications may be allowed to interact with and provide access to the invention. Additionally, there are also non-GUI software methodologies that will allow data to be read/written to the invention account data repository with the intent to serve the same purpose as the GUI.

Electronically represented data may also be converted by the invention to a paper-printable format including but not limited to Adobe's Portable Document Format, browser print method or fax.

Electronically represented data may be transmitted out of the invention system 10 via various data export' methodologies. The formats of those methods contain but are not limited to the HL7 protocol, X12N ANSI format and various other software Application Protocol Interfaces (APIs).

Provider Enrollment Process.

While patient accounts can be created by any person, healthcare providers require a level of verification prior to becoming recipients of patient data. The invention allows for an electronic entity validation process by means of utilizing government records required by healthcare entities.

The system 10 and method of the disclosure includes an automated process by which certified healthcare entities wishing to participate must be capable of receiving an authorization code. The authorization code may be given verbally over an automated phone call originating on behalf of the invention to a phone number chosen by the healthcare entity wishing to enroll. The authorization code may be transmitted via facsimile originating on behalf of the system 10 of the present disclosure to a facsimile number chosen by the healthcare entity wishing to enroll. The authorization code may be printed and mailed via post originating on behalf of the invention to an address chosen by the healthcare entity wishing to enroll. The designated phone number, facsimile number, or address may be selected from a list on file according to government records.

Additionally, the authorization may be given to a healthcare entity wishing to enroll after completing a manual paper authorization form and submitting it.

Custom Provider Forms.

Healthcare entities may utilize the system 10 and method of the disclosure to create electronic versions of their current paper forms or new electronic forms. The system 10 and method establishes a data gathering form structure designed to get the appropriate information collected by a patient for purposes of the healthcare entity.

Electronic forms can be created by the user on behalf of the healthcare entity by the same means to access the system 10 as described herein. An electronic form can be defined as a group of questions within the system 10. The questions are defined electronically, and may be assigned properties that allocate which type of answer is attached during usage of the system 10 through a registration performed by the patient. Answer sets can contain free text, a single option from a list of possibilities, multiple options from a list of possibilities, or may be represented visually in relation to a presented diagram, as nonlimiting examples.

Electronic forms and their subsequent question and answer pairs can be assigned to a particular healthcare entity, specific appointment type or other unique circumstance that can be differentiated between any two registrations.

Given that ability, patient registrations have the ability to present questions derived from custom electronic forms created by the healthcare entity or inherent to the system 10 to patient registrations dynamically. A patient registration can be presented with some questions for one registration while some, none, or all of those same questions (or data collection points) may be presented on another registration based on any number of system 10 capable factors.

Each data capture point on the electronic forms, identified to the patient as a question, has the ability to link its received input to discrete data contained within the patient's account. For example, if a provider form asks for “Patient's First Name”, this data may be pre-populated from the patient's account that already contains that particular data field.

Electronic forms have the ability to be presented in a layout and format that would allow a healthcare entity to print them out of the invention in a blank format where no questions were answered and all of the same questions presented during an electronic registration would also be present on the non-electronic printed paper. This allows healthcare entities to maintain a constant workflow in regards to data capture from patients, whether patients use the electronic version of the system 10 or not.

### Example

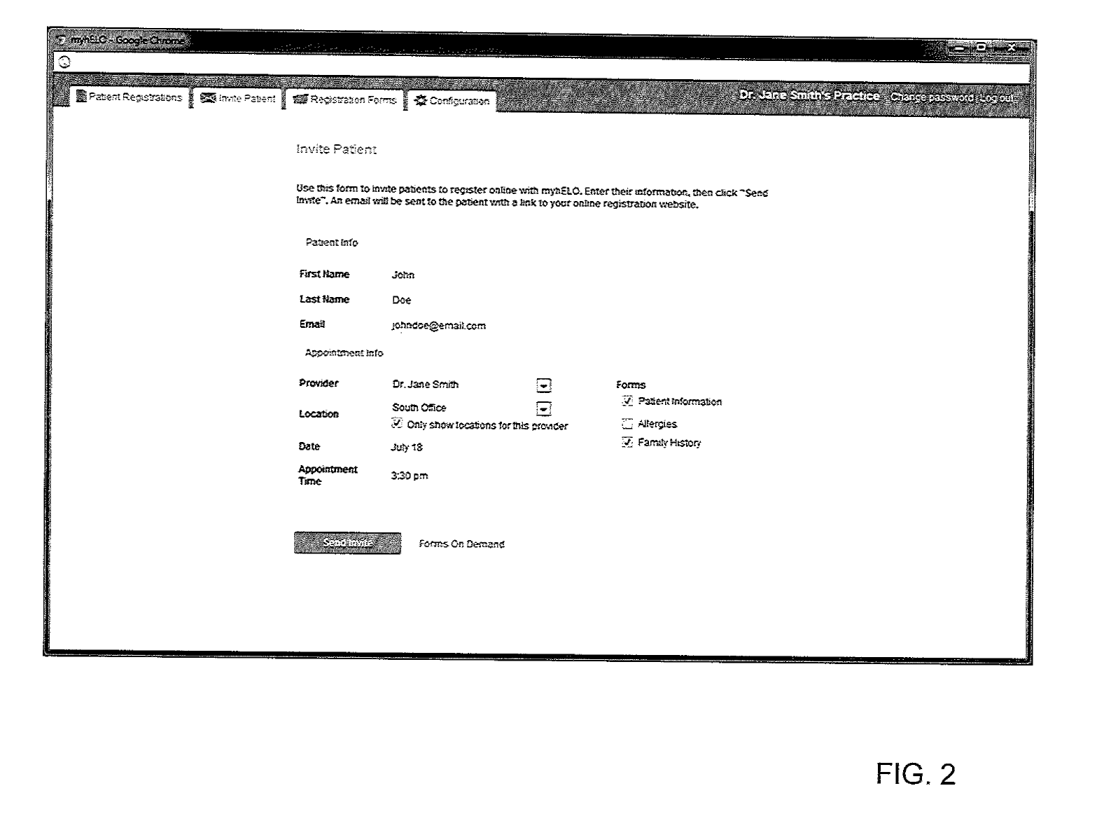

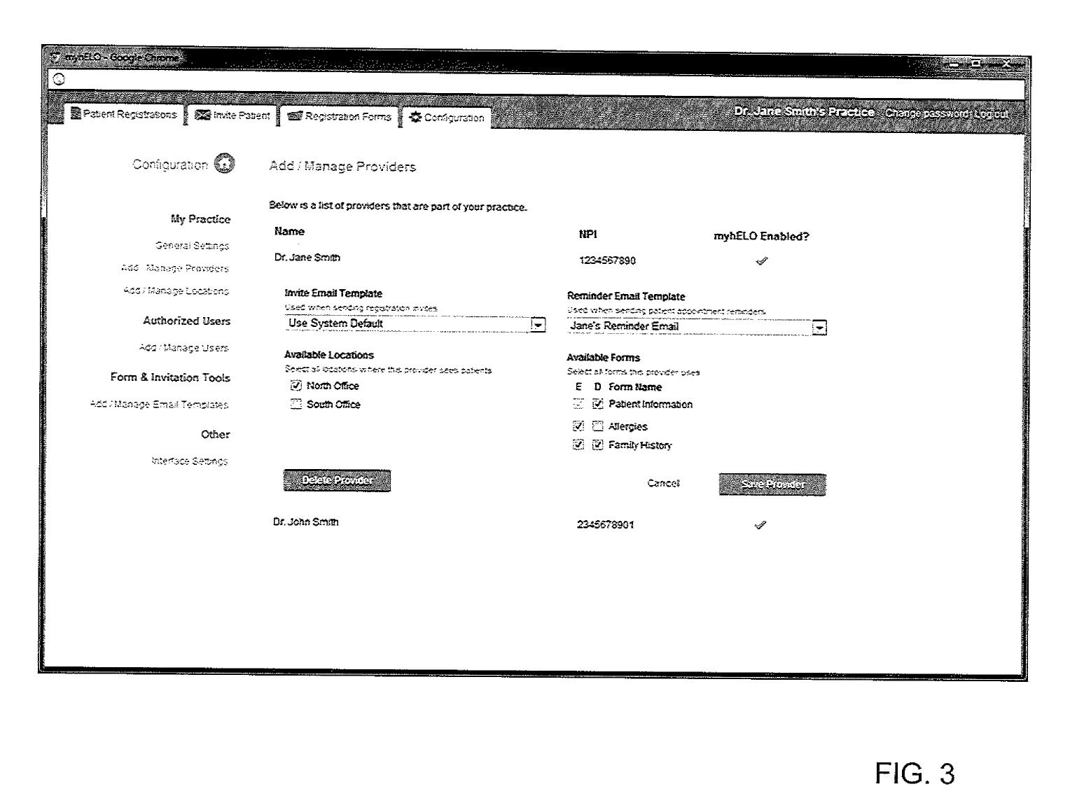

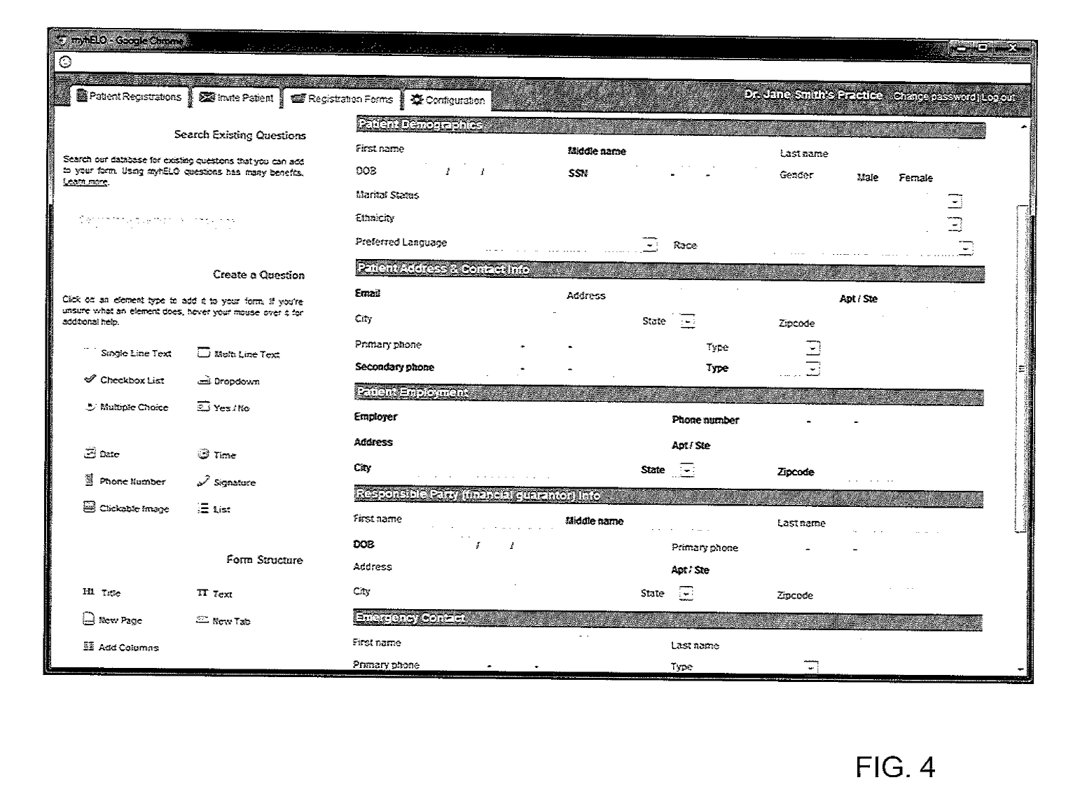

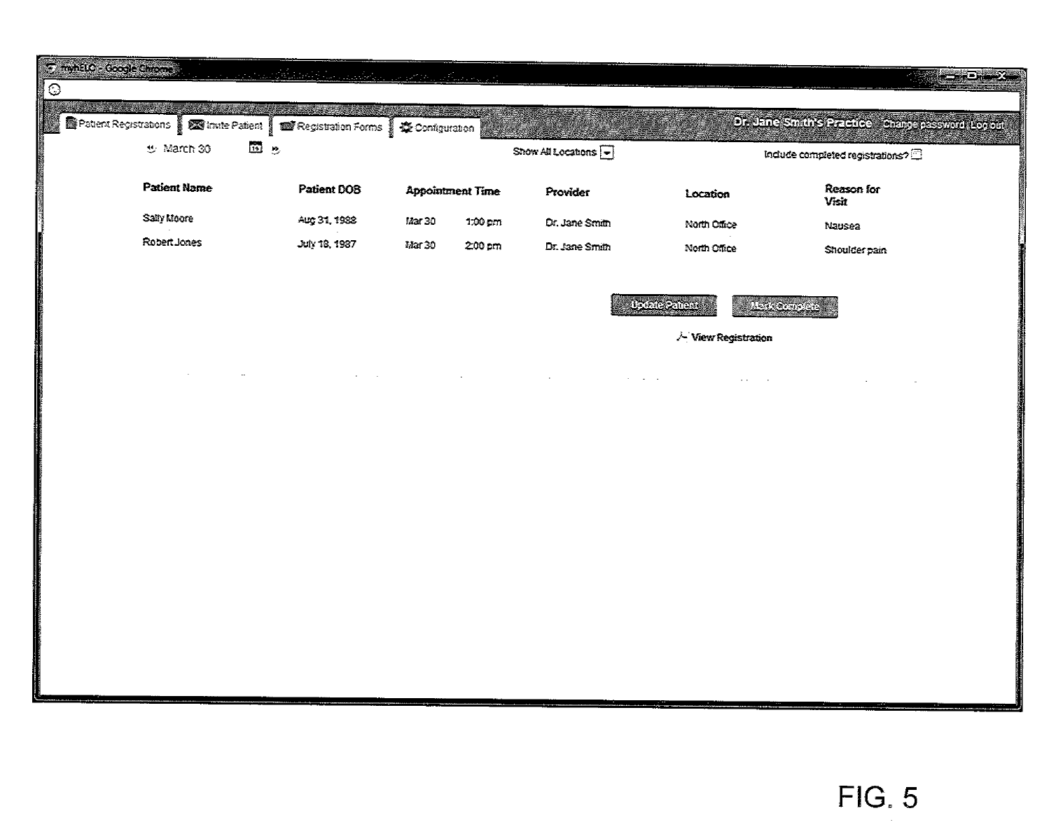

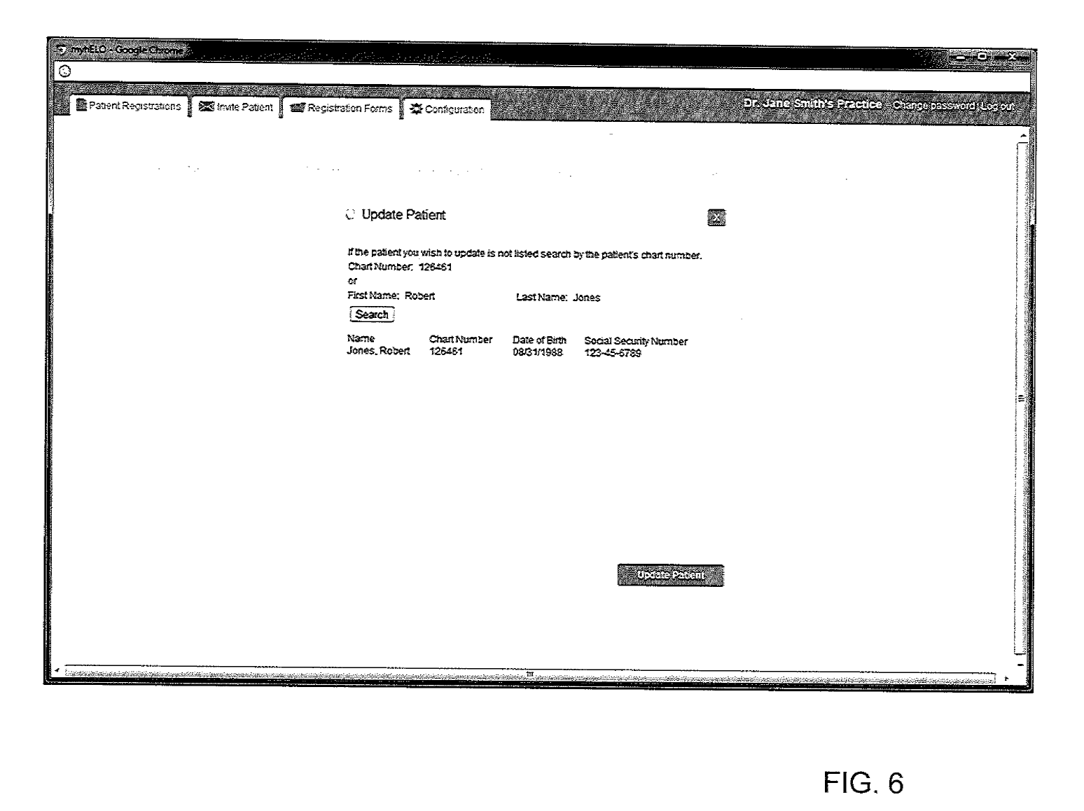

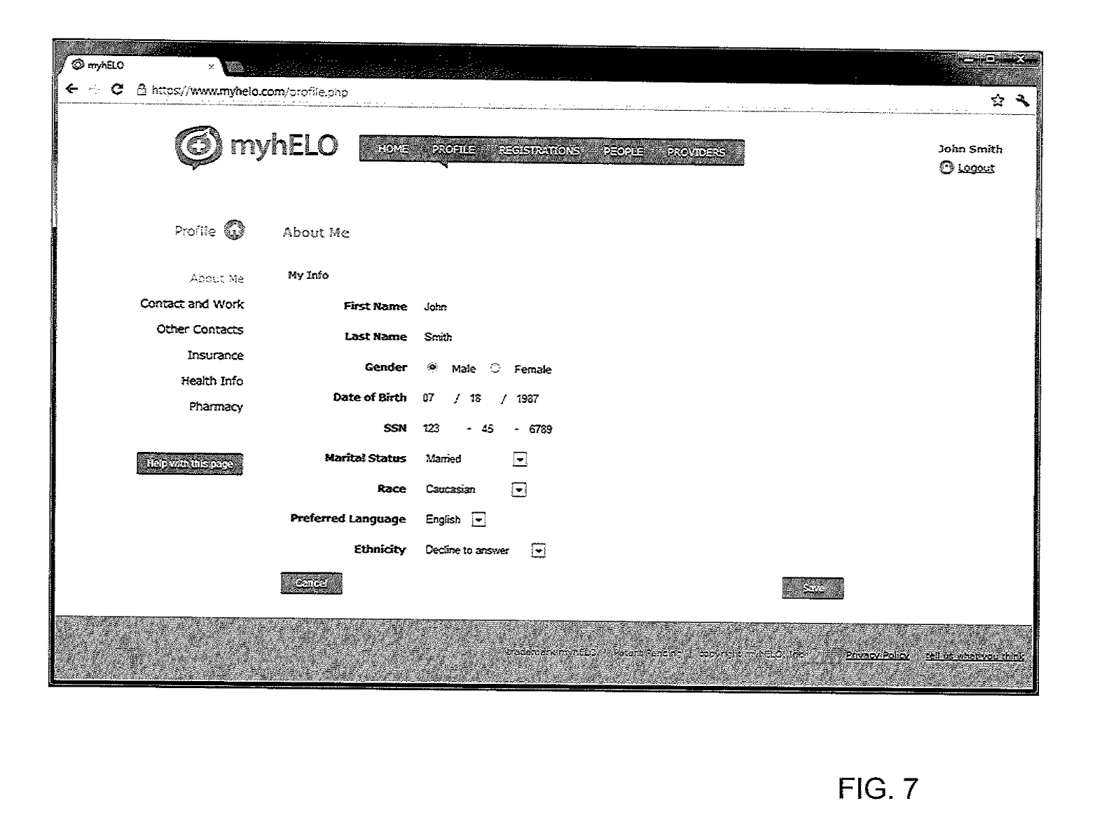

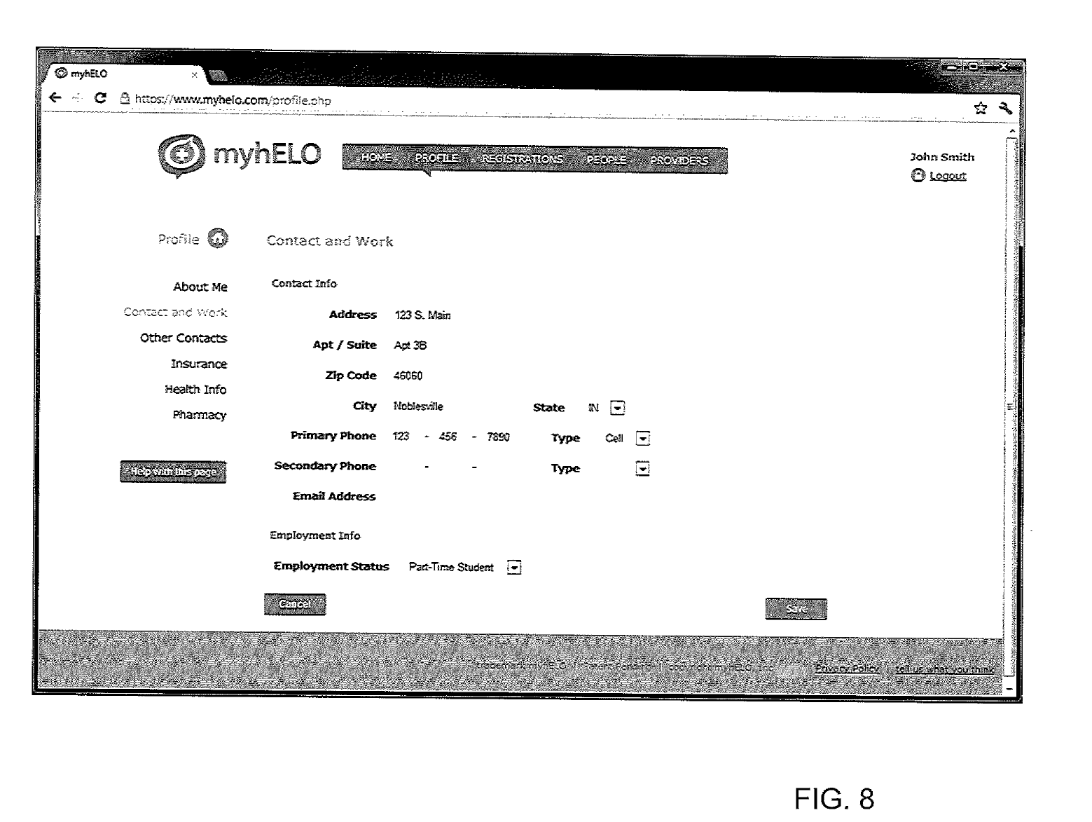

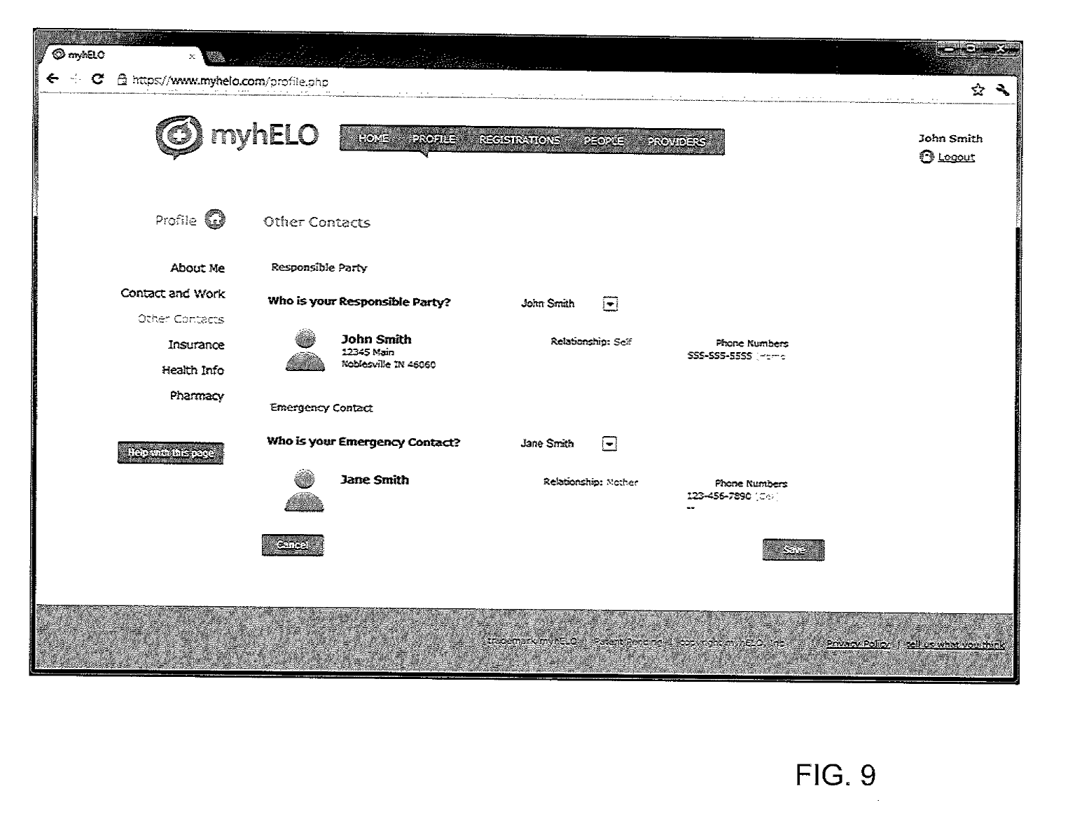

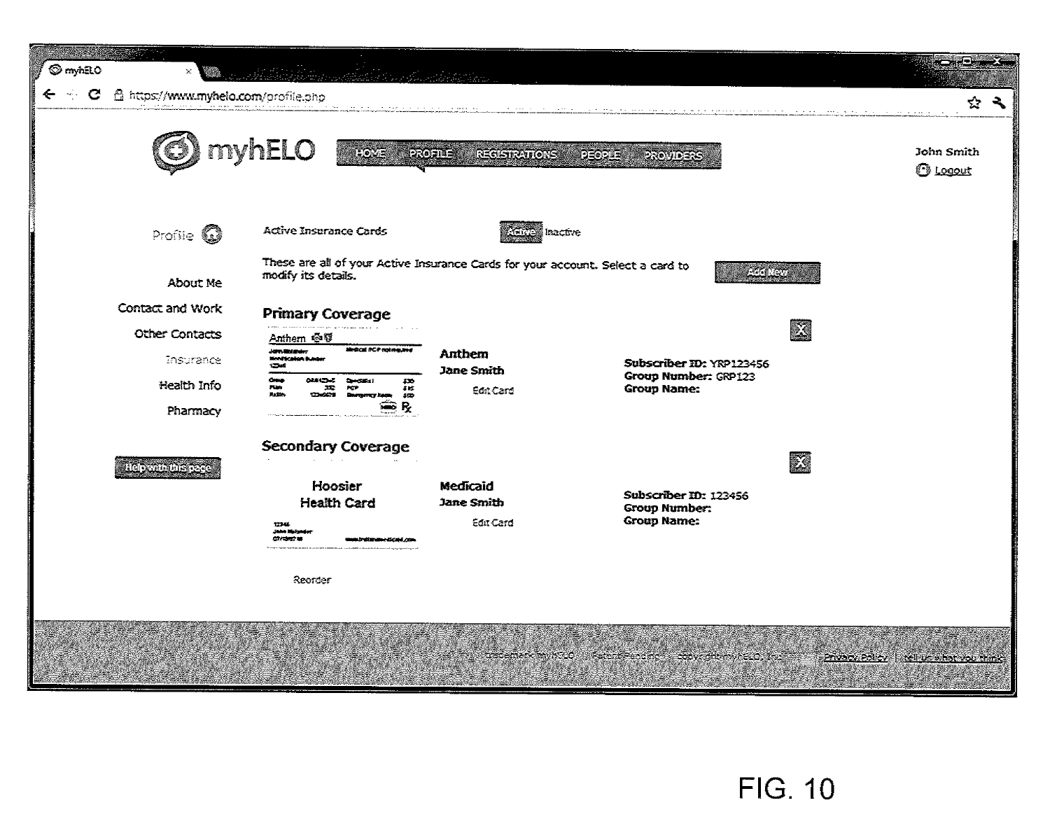

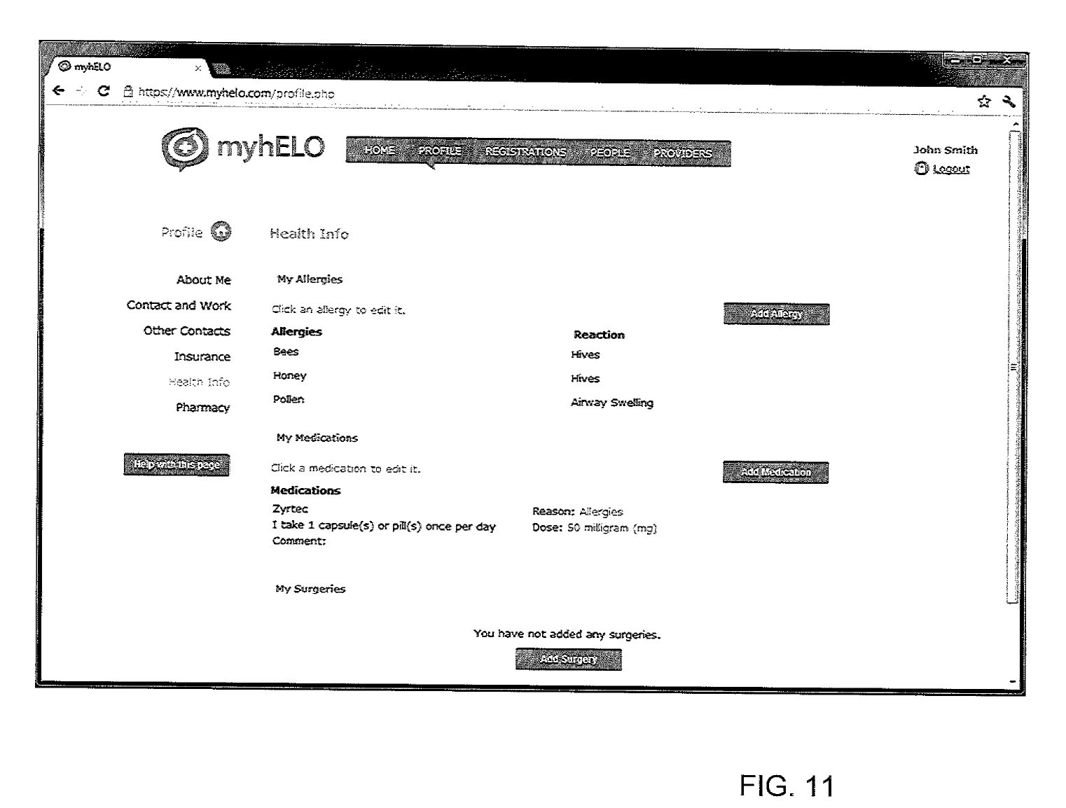

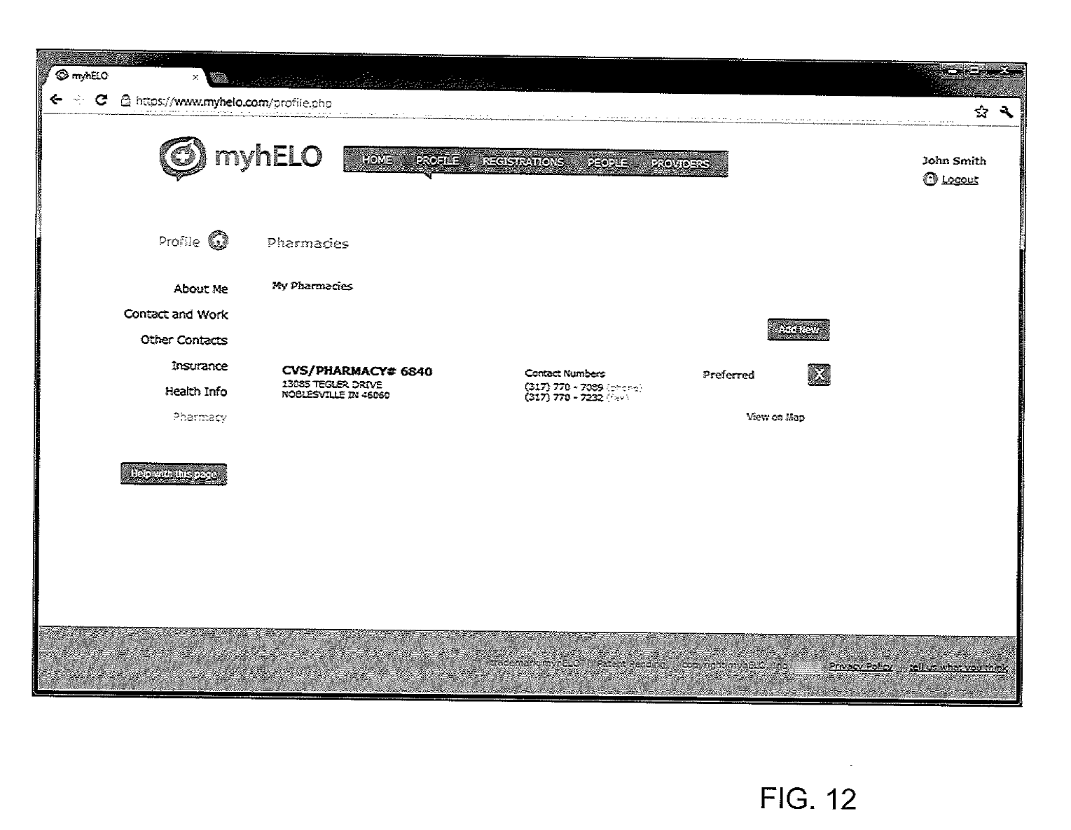

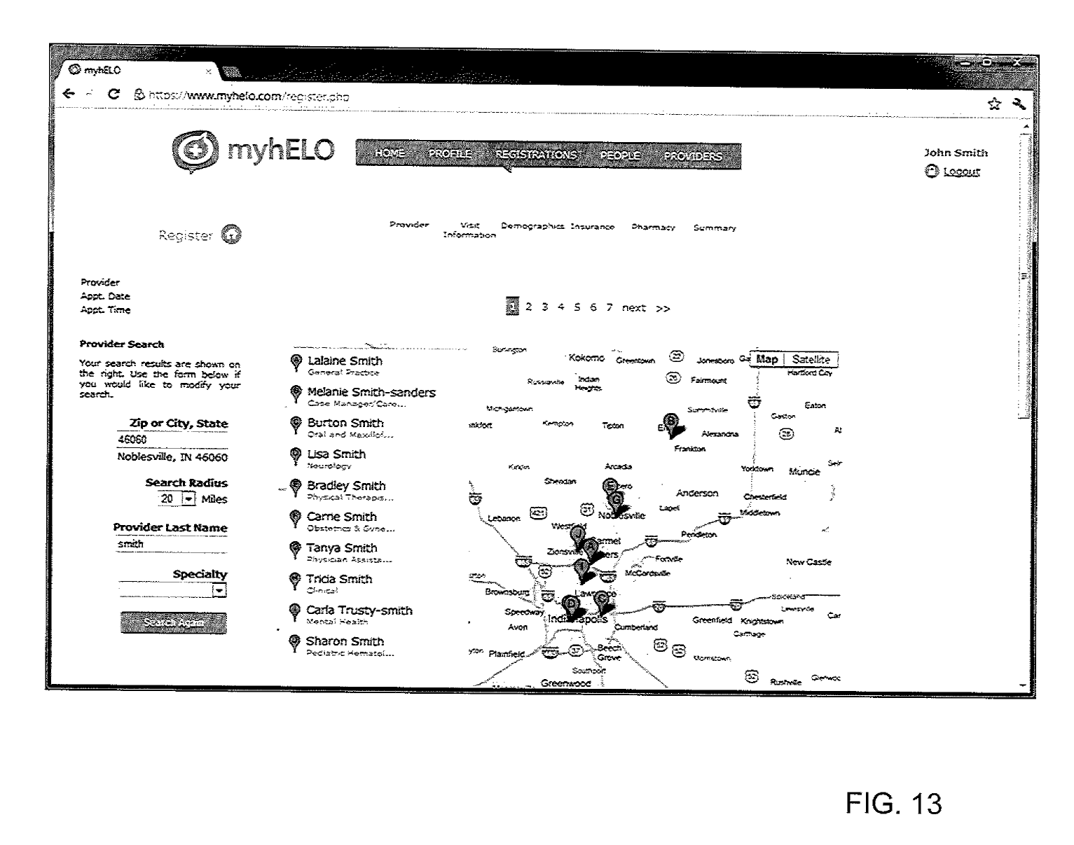

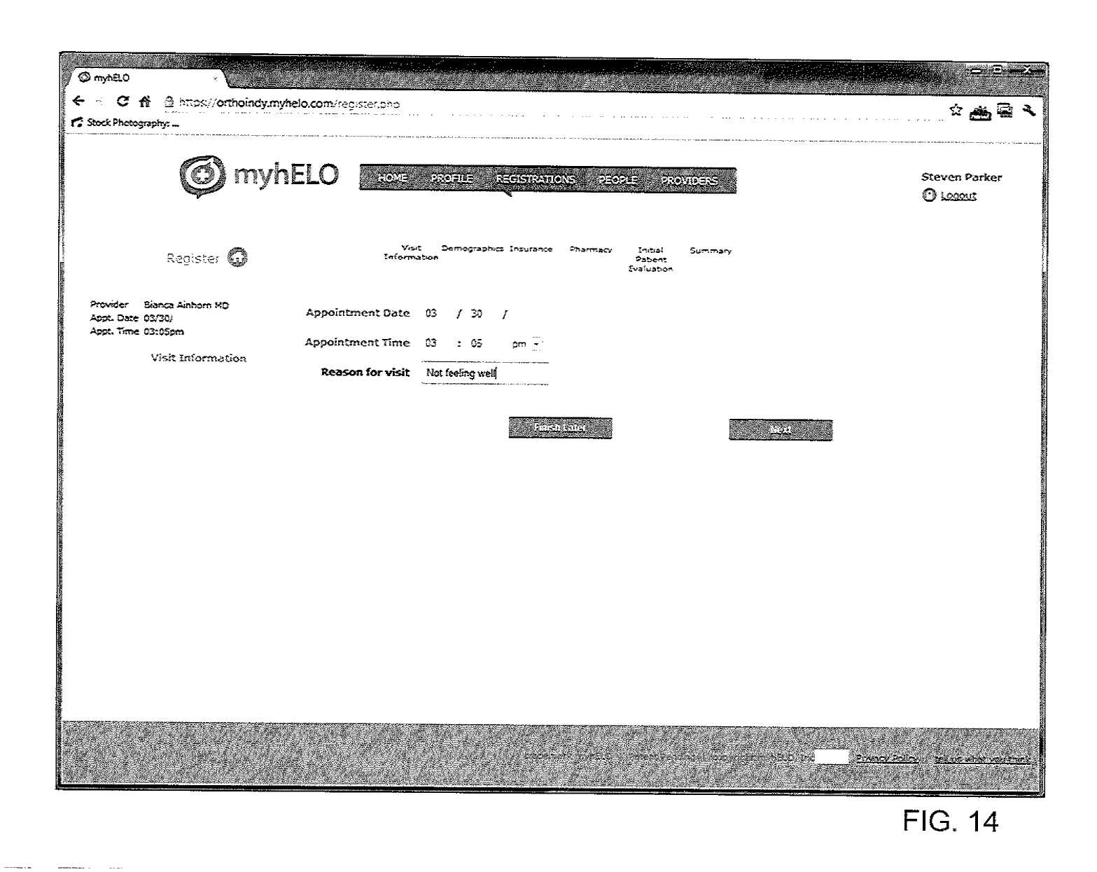

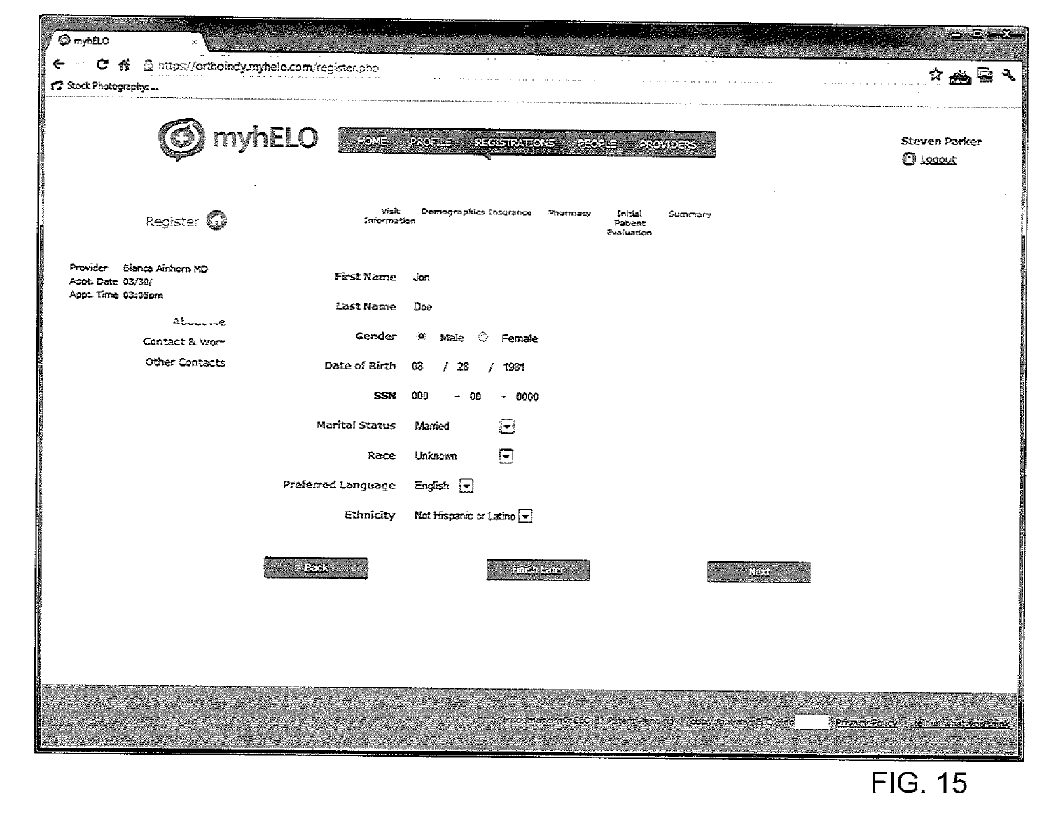

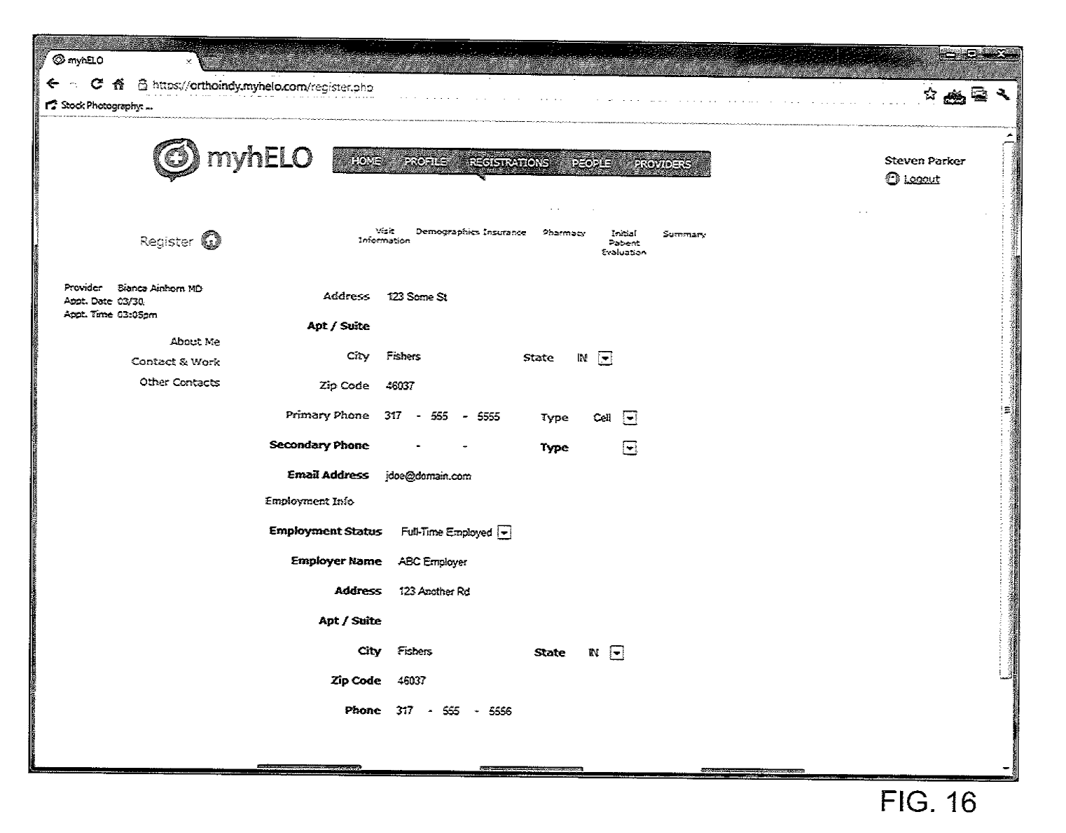

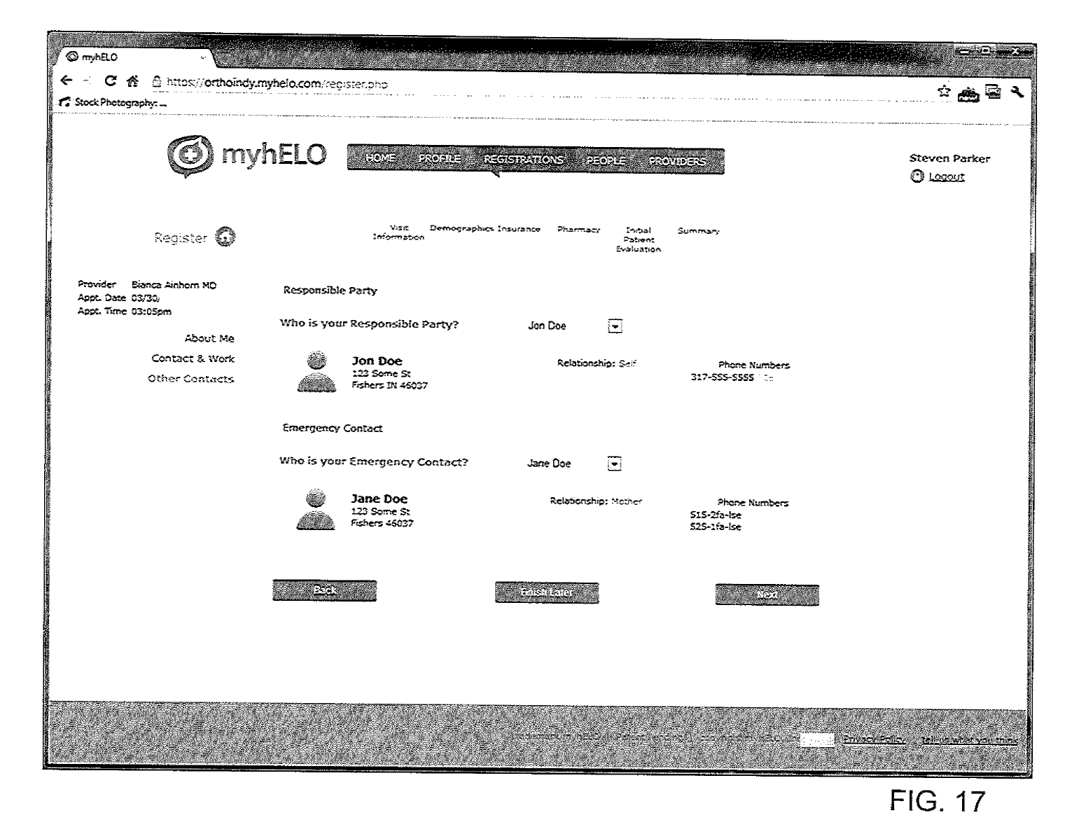

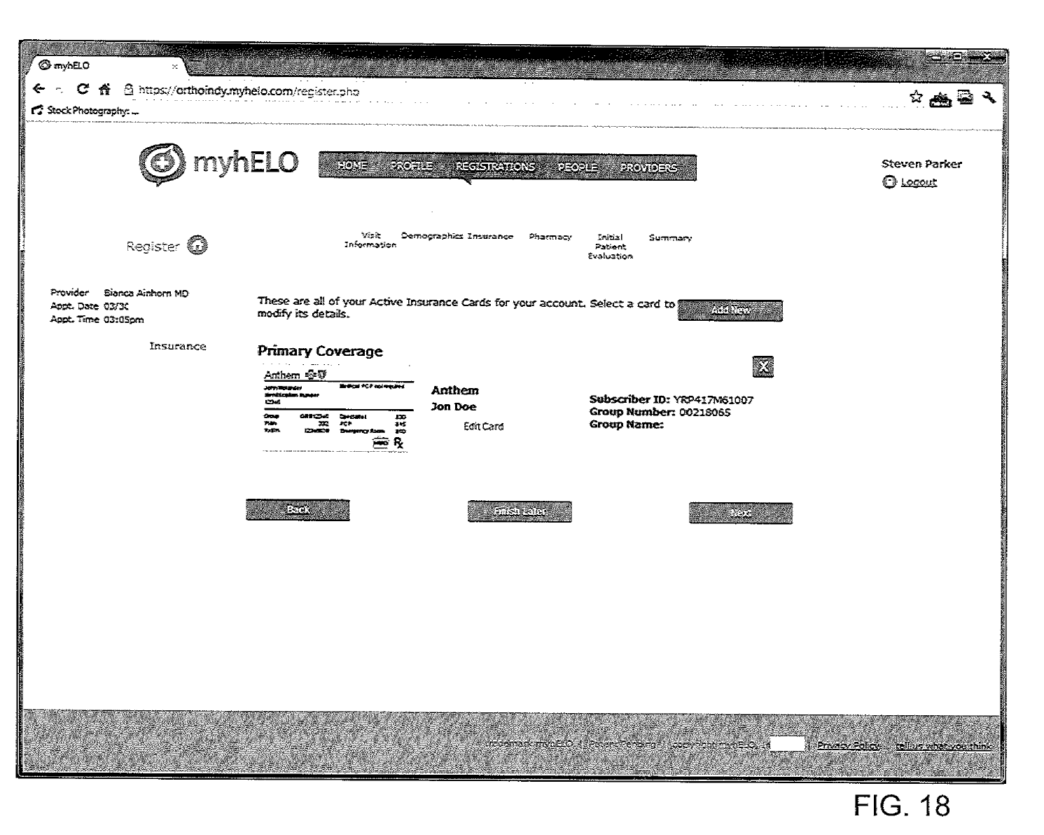

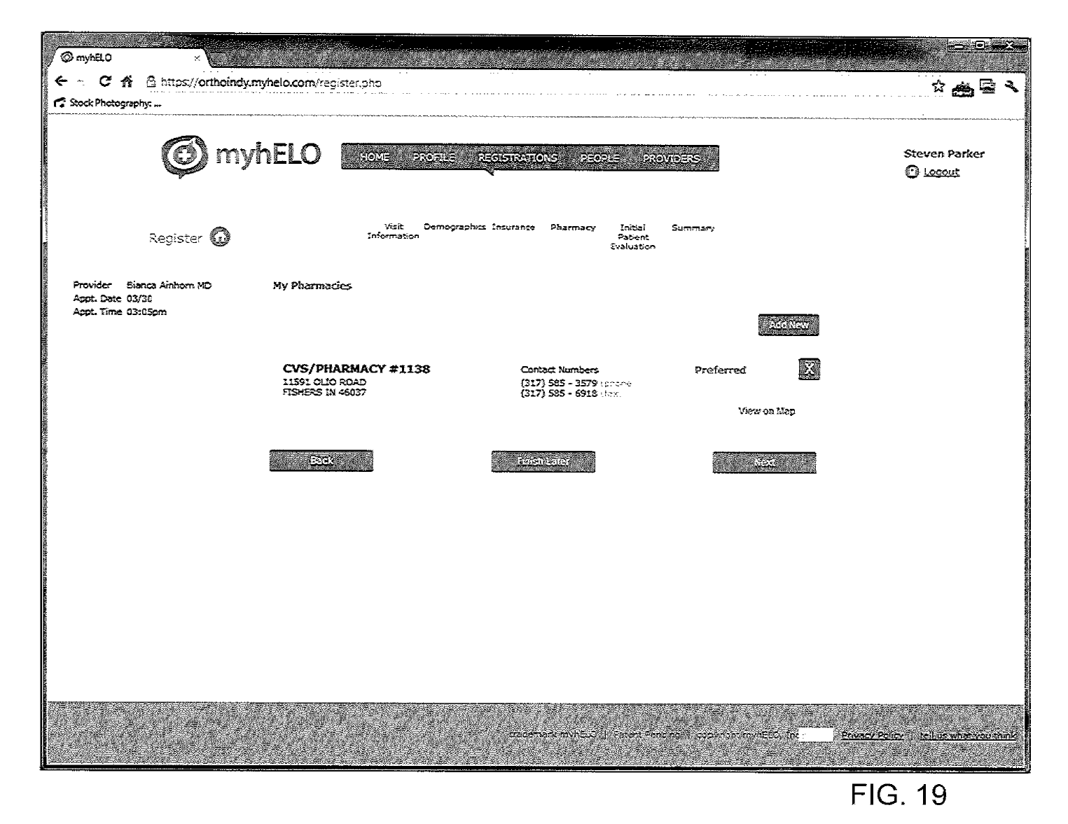

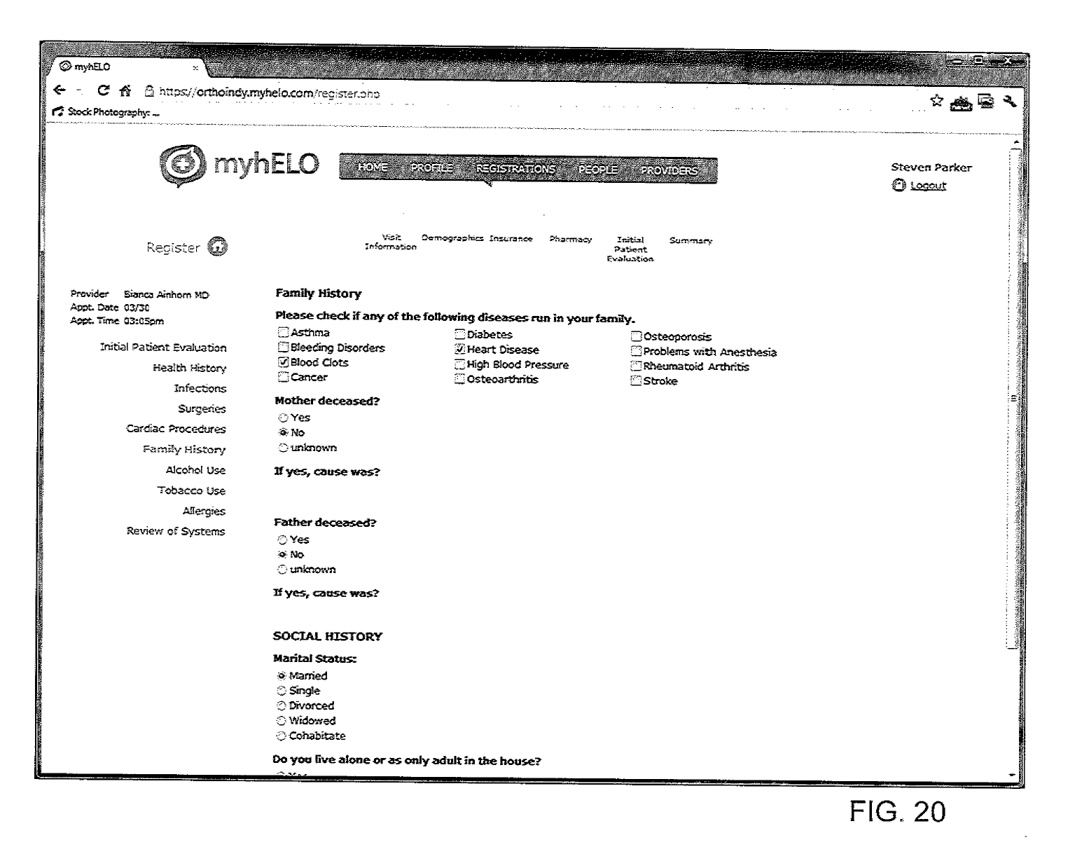

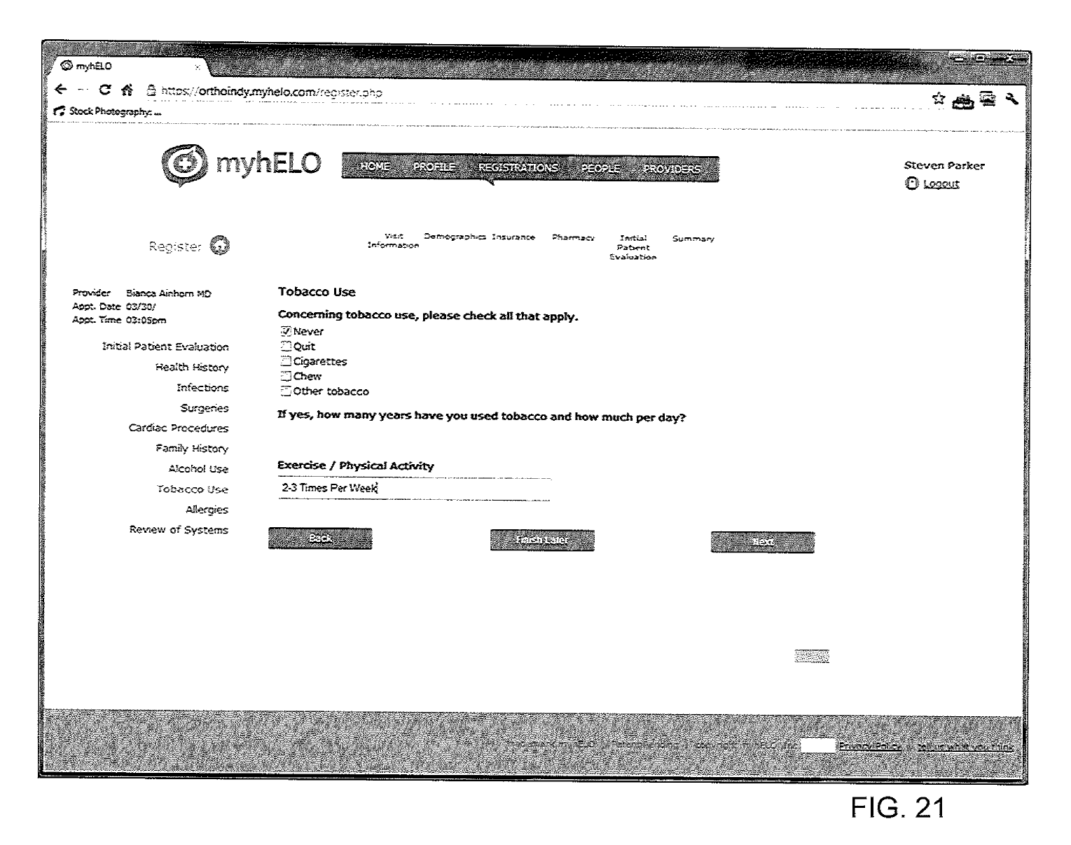

An exemplary embodiment of the system 10 described hereinabove is known as the myhELO® system, and is shown by way of illustration in FIGS. 2-21. The myhELO® system helps patients spend less time waiting and to help doctors spend less time doing paper work so that everyone can focus on what matter most: the patients' health.

The concept is easy: simplify the registration process; give the doctor's office better information; and do it all without costing either party any money.

myhELO® does it for you:

By using myhELO®, the patient can search for over 300,000 providers across the United States by location, name and specialty. The myhELO® Provider Search gives the patient the ability to find the right physician for its needs, and then save them to the patient's account favorites, and even share them with other myhELO® members. The patient can add and remove ‘favorite’ providers at any time.

The patient can create a registration for an upcoming appointment and attach it to one of its providers to create a visit. By entering your registration online and at the patient's convenience, the patient does not have to complete the paperwork at the healthcare provider's office. The patient's registration document can be sent directly to the healthcare provider, printed out, and even saved with a time-limited (e.g., a 48 hour) passcode sent via txt to the patient's phone, which allows any healthcare provider's office to obtain the patient's information.

Insurance Verification: If the patient has insurance, the patient and its healthcare provider will take advantage of the fact that the myhELO® system verifies the insurance using an eligibility tool. This verification can also be used to see outstanding deductible and co-insurance amounts so that the patient can understand how much a visit to the healthcare provider will cost the patient.

Saved Data: Future visits with current and new healthcare providers become even easier because the patient's information is already saved and simply re-copied for the patient's next visit. All of your visits and corresponding history are logged to the patient's account.

Proxy: If access to accounts for a spouse or children is desired, the patient can manage the spouse's or children's accounts with proxy access using the patient's own login, as long as given access to do so. The myhELO® system allows the patient to link everyone in the patient's family, if desired, so that the patient can manage the way the patient likes, from one place and one login.

Entering personal information online is secure with the myhELO® system. The myhELO® website and methods are HIPAA compliant, and the data is encrypted for everyone's protection. The myhELO® system is further secured by the fact that the patient chooses whom to give the patient information.

New healthcare providers may get started by the patient creating a visit for the new healthcare providers, and using a 48 hour passcode so that the new healthcare providers can access the patient's information.

Payment method storage and payment prediction technology for patients: By using 835 or 837 or data scraped from a Medicare Master file, the myhELO® system can build a large index of fee schedules for doctors. Using this fee schedule data, the myhELO® system can then determine the charge amounts for services, and then combine them with the benefit eligibility information received from patient registrations to predict patient out of pocket amounts due. 835 or other EOB information may be imported directly by the provider or received directly into the myhELO® system by using a clearinghouse to obtain the data, potentially passing it on to intermittently view the data for copying purposes.

Physicians may also manually modify or update their fee schedules if they choose to not go through the auto process described hereinabove. One of ordinary skill in the art should also understand that having 835 transaction data also allows for proration calculations to be performed.

The patient may also load in payment methods for its account (e.g., credit cards, PayPal, Google payment accounts, etc.) so that the patient may give the healthcare provider access to debit its account upon claim adjudication. This may include setting up payments plans with auto subscription services.

The patient may grant the access for the payment information with the myhELO® system registration, and then the healthcare provider has access to ‘initiate’ the transaction via the myhELO® system without ever seeing the true payment method of the patient. Limits imposed by the patient, potentially driven from a payment estimator, may also be permitted. Advantageously, this allows for electronic account payment entirely through the myhELO® system.

Immediate scheduling: Healthcare providers are permitted to manage a personalized “myhELO® schedule” that the healthcare provider may use to designate appointment slots that would be allocated for myhELO® appointments. These appointments may then be auto filled by the patient online. This concept is similar to the instant allocation of table reservations via online services or hotel allotments, as nonlimiting examples.

From the patient perspective, they may search for a healthcare provider and not just request an appointment, but truly book the appointment through the myhELO® system.

The myhELO® system may be integrated with a variety of healthcare provider systems including, as nonlimiting examples, Google Health™ and MS Healthvault™.

Physician user submitted rankings may also be provided using the myhELO® system, for example, in a “Dr. Finder” module of the myhELO® system.

The PASS component may also allow the healthcare provider to provide their own questions along with some standard PASS items. The PASS component may use a ‘virtual human body’ to help the patients describe their problems. These problems and this tool would be designed around the MU requirements and worked into an EMR integration suite. ICD10 is useful as a direction guide for this tool. In essence, this component makes the patient do the work for the doctor.

The PASS area may contain a ‘kiosk’ enabled version so that providers may use one or two personal computers to allow patients to electronically use the PASS tool. This tool may be tablet based, for example, provided as an iPad or Android application.

Healthcare Providers: Every healthcare provider knows that the costs of practicing medicine are increasing. While technology has provided many enhancements in the clinical arena of healthcare, the administration advancements have lagged. Discontinuity between systems, ever increasing technical requirements and compliance standards, and reduced compensation make it more difficult for healthcare providers to focus on medicine. The myhELO® system advantageously permits the healthcare provider to focus more on medicine, and less on administration.

What's in it for the healthcare provider: Providing the patient with free online registration is an advantageous feature to provide to the patient. It saves on the time required for the registration process for the patient's appointment, but more importantly, it gives the healthcare provider better data. It is known that failing to obtain the proper information on the frontend increases the cost to collect on the backend exponentially. By using the data obtained from myhELO® system registrations, the healthcare provider receives several advantages, including up-to-date demographic, contact, payment and verified insurance information at no cost.

Free Eligibility: By building a clearinghouse, the myhELO® system allows for the provision of eligibility verifications, including co-payment, co-insurance and deductible amounts to myhELO® registrations for the majority of patients.

myhELO® Office Hours: The myhELO® Office Hours feature allows the healthcare provider to set up a schedule of times available for patients to schedule their own appointments online without having to call in. The myhELO® system ensures that every patient that comes through the system is verified and pre-registered properly. The healthcare provider can also set the times and appointment type criteria. The healthcare provider is able to limit the number of appointments made, and even filter on appointment type so that the healthcare provider does not receive more patients than it can accommodate within a given window of time. The service provides an extreme convenience for patients. The myhELO® system may also permit a “pre-payment” option for appointment hours.

Pre-Payment with Payment Estimation: The myhELO® system allows for a co-insurance/deductible/co-payment estimation based on the charge and insurance of the patient. Using the healthcare provider version of the myhELO® website, doctors can enter the estimated charge amounts and obtain a good faith estimate of the patient responsible portions of the upcoming bill. This allows for up-front payment collections, or the healthcare provider can choose to leverage the patient's myhELO® account for permission to charge the account through their linked payment method when the bill comes due.

Direct Import of Data: The myhELO® system may also provide the healthcare provider with the ability to accept direct imports of myhELO® patient registrations directly into the healthcare provider's Practice Management/EHR System. By utilizing this process, the patient intake process is reduced to a brief check-in by the patient and the healthcare provider's staff. This saves time, money and increases patient satisfaction.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A method for standardizing patient registration, the method comprising the steps of:
allowing a patient to one of create an account on a data management system and manage the account that has been previously created on the data management system, the account having patient information entered into the account by the patient;
permitting the patient to authorize a sharing of at least a portion of the patient information in the account with a healthcare provider; and
providing the healthcare provider with access to the portion of the patient information in the account authorized for the sharing by the patient via the data management system.

2. The method of claim 1, wherein the patient information includes at least one of demographic information about the patient, a responsible party to the patient, an emergency contact to the patient, a subscriber listed for each insurance coverage, an insurance policy identification number, a patient medical history, a family medical history, a social history, an active prescription listing, an historical prescription listing, a healthcare provider specific information, and data requested by the healthcare provider.

3. The method of claim 1, wherein the patient is permitted to authorize a sharing of the patient information of the account with an other entity different from the healthcare provider.

4. The method of claim 3, wherein the other entity includes a family member of the patient.

5. The method of claim 3, wherein the other entity include an other healthcare provider.

6. The method of claim 1, wherein the account is one of created and managed through an Internet website in communication with the data management system.

7. The method of claim 1, wherein the data management system issues an authorization code to the healthcare entity in order to participate.

8. The method of claim 7, wherein the authorization code is issued to one of a plurality of validation sources that the healthcare entity has previously selected in order to verify that the healthcare provider is permitted to receive the client information.

9. The method of claim 8, wherein the validation sources include at least one of a telephone number, a facsimile number, and a mailing address.

10. The method of claim 1, further comprising a step of permitting the healthcare provider to create a data gathering form structure within the data management system, the data gathering form structure configured to collect the patient information relevant to the healthcare provider's services.

11. The method of claim 10, wherein at least a portion of the data gathering form structure is pre-populated with the patient information from the account.

12. The method of claim 1, wherein the portion of the patient information in the account accessed by the healthcare provider includes an indicator of the patient's eligibility for treatment.

13. The method of claim 12, wherein the indicator is a validation of the patient's insurance.

14. A data management system for standardizing patient registration, comprising:
a database;
a patient interface in communication with the database and configured to transfer patient information in an account on the database to and from the database;
a processor in communication with the database, the processor configured to retrieve the patient information; and
a healthcare provider interface in communication with the database and configured to receive at least a portion of the patient information in a standardized format.

15. The system of claim 14, wherein the processor is configured to validate a patient's eligibility for treatment based upon the patient information, and the healthcare provider interface is configured to receive an indicator of the patient's eligibility for treatment.

16. The system of claim 14, wherein the processor analyzes and evaluates the patient information upon an instruction set embodied within a computer readable medium, the instruction set including processor executable instructions.

17. The system of claim 16, wherein the processor executable instructions include instructions for organizing and standardizing a data into a pre-defined format, establishing a connection with a communication portal of an insurance company, validating an insurance eligibility, generating a feedback of information to the patient and the healthcare provider, and managing an electronic scheduler.

18. The system of claim 14, wherein the account includes pre-defined fields that are populated by the patient.

19. The system of claim 18, wherein the pre-defined fields are based upon a universal registration template including information required by a typical physician in order to register a new patient.

20. A method for standardizing patient registration, the method comprising the steps of:
providing a data management system of standardizing patient registration, the data management system including a database, a patient interface in communication with the database and configured to transfer patient information in an account to and from the database, a processor in communication with the database, the processor configured to retrieve the patient information, and a healthcare provider interface in communication with the database and configured to receive at least a portion of the patient information in a standardized format;
receiving authorization to access the at least the portion of the patient information in the account from the patient; and
accessing the portion of the patient information in the account via the healthcare provider interface, the portion of the patient information provided in a standardized format.
